(19) United States
(12) Patent Application Publication
(10) Pub. No.: US 2010/0032476 A1
(43) Pub. Date: Feb. 11, 2010

(54) PRINTED PRODUCT RFID

(75) Inventor: Heinz Möckli, Grüt (CH)

Correspondence Address: PAULEY PETERSEN & ERICKSON, 2800 WEST HIGGINS ROAD, SUITE 365, HOFFMAN ESTATES, IL, 60169, US

(73) Assignee: Ferag AG, Hinwil (CH)

(21) Appl. No.: 12/311,791

(22) PCT Filed: Oct. 12, 2007
(86) PCT No.: PCT/CH2007/000503

§ 371 Date: Apr. 13, 2009

(30) Foreign Application Priority Data
Oct. 13, 2006 (CH) 1633/06
May 14, 2007 (CH) 795/07

(51) Int. Cl. G06F 17/00; H04Q 5/22; G06K 19/06

(52) U.S. Cl. 235/375; 340/10.1; 235/492

(57) ABSTRACT

A method for processing flexible, two-dimensional products (30, 32, 36, 38) during the print further processing, in which at least one product is provided with an RFID tag (100, 200, 200a, 200b). The RFID tag or tags (100, 200, 200a, 200b) contains or contain at least one piece of control information and/or at least one piece of product information. This information is used for inspecting and/or controlling a work step for the products (30, 32, 36, 38).

### FIELD OF THE INVENTION

The present invention relates to a method for processing flexible, two-dimensional products in accordance with the preamble of Patent Claim 1, flexible, two-dimensional products in accordance with the preamble of Patent Claim 16, and to a system for producing flexible, two-dimensional products in accordance with the preamble of Patent Claim 17.

### BACKGROUND OF THE INVENTION

The prior art discloses radio frequency identification transponders (subsequently called RFID tags), and the use thereof in intelligent labels (also called RFID or smart labels for short) is becoming increasingly important. The bases for RFID technology, which allows data to be transferred by means of radio waves contactlessly and without visual contact between an RFID tag and a transceiver, are known and do not require further explanation at this juncture. The systems for wireless data transmission, for example for identifying products provided with RFID tags, usually comprise the following three components: RFID tag, transceiver, which is used to read data from the tag or to write them to the tag, and a superordinate IT system which manages the relevant data. For the supply of power to the RFID tags, a distinction is drawn between passive, semiactive and active RFID tags, the text below discussing only passive RFID tags in more detail, which obtain their power from the electromagnetic field which is produced by the transceiver and received by means of inductive, or capacitive, coupling in the local area via the antenna.

Systems with inductive coupling currently operate primarily in low frequency ranges from 30 to 500, preferably 100 to 135, kHz, at a range of up to one metre and in high frequency ranges from 3 to 30, preferably 13.56, MHz, at a range of approximately 1.7 metres. Similarly to the frequency range, at the low frequencies (LF) both the data transfer rates and purchase prices are low. LF-RFID tags are usually fitted with chips having a storage capacity of up to 2 kbits. At the high frequencies (HF), which have higher data transfer rates but also a higher price, the range likewise corresponds to approximately 1.7 metres. Depending on the type of storage, the available storage space ranges from the storage of simple identification numbers through to the storage of complex data, such as manufacturer, best-before date, date of manufacture, selling prices, etc.

Of the production costs for the known passive RFID tags, currently approximately 50% can be attributed to the actual chip (subsequently also called tag IC) and the remainder can be attributed to the coupling element in the form of a coil or antenna (subsequently called antenna), the connection between the antenna and the chip, further passive components and the support material for the tag.

Very simple systems for wireless data transmission comprise tags without a tag IC, in which the transponder function is essentially undertaken by an antenna or another coupling element. Such simple transponders act as electronic data storage media for a piece of 1-bit information and are accordingly subsequently referred to as 1-bit tags. The presence of an activated 1-bit tag in the transmission and reception range of an appropriately customized reader in an appropriate range can be detected, which means that in the simplest case it is possible to “read” the presence or absence of the transponder as a piece of 1-bit information. The use of such IC-less 1-bit tags is widespread in systems for protecting goods against theft.

Frequently, this involves the use of radio frequency tags, which have an electrically conductive coil which, together with a capacitor, forms a resonant circuit. In an electromagnetic radio frequency field which is generated by the transceiver and which is in tune with the resonant frequency of the radio frequency tags, the resonant circuit modulates the transmitted power of the system by absorbing energy and can be detected by the transceiver as a result. The resonant circuit can be irreversibly electrically deactivated by overcharging the capacitor and hence detuning the resonant circuit.

The electromagnetic tags, which comprise strips of magnetically soft materials, for example, can be magnetized to the point of saturation in a sinusoidal magnetic alternating field at a frequency of 10 Hz to 20 kHz, for example, and then detected by means of harmonics in the alternating field. The electromagnetic tags can be reversibly activated and deactivated in a known manner.

Further 1-bit tags are known as harmonic tags, since they respond to waves sent by the transceiver with harmonics and thereby indicate their presence in a reception range of the transceiver to the system. Harmonic tags, like acoustomagnetic tags, preferably involve the use of amorphous metal strips which are fitted with magnetically hard elements. These tags can be reversible deactivated by magnetizing the magnetically hard elements and the accompanying shift in the harmonic arrangement. Different arrangements of the magnetically hard elements allow tags with a wide variety of harmonic patterns to be produced, so that different tags can be individually detected.

In order to avoid interference in reserved frequency ranges (e.g. for radio stations, mobile radios, mobile phones, etc.), national, regional and/or international radio regulations precisely stipulate what frequency bands are available, particularly for the RFID applications. Primarily, RFID applications can use the ISM frequencies, which are approved for industrial, scientific and medical applications.

The Hitachi company supplies a miniaturized RFID tag called the “μ-chip”, having a size of just 0.15×0.15 mm and a,thickness of 7.5 microns. The same company has presented prototypes of an RFID chip produced using the 90-nanometre process, which now measures only 0.05×0.05 mm×5 μm (without antenna) and has a 128-bit ROM for holding a 38-digit ID code. The ROM of these RFID chips can have information written to it using an electron beam during its actual production. The transmission range at 2.45 GHz is 30 centimetres.

During production of the tags, both the antenna and any capacitors and/or ICs can be produced by printing methods. As explained in more detail below, production methods discussed in the prior art involve the antennas, for example, being put onto films by means of screen-printing methods or by means of ink-jet methods, and these films then being laminated and processed further to form adhesive labels.

WO 2005/021276 proposes not only printing a substrate in an online process using the functionality ink in a known manner, but also printing using the functionality electrical conductivity or electrical semiconductivity. An application example proposed for the additional functionality is the creation of radio frequency identification transponders on the substrate, for example a package. In accordance with a first embodiment, only the antenna for the RFID transponder is printed, and the chip is then bonded to the antenna inline so as to make electrical contact. In accordance with a second embodiment, the printing device is also used in a plurality of steps to print all the active components of the RFID transponder, with the transistors being connected up to form semiconductor chips.

DE 10 2005 026127 discloses a printing method in which, likewise inline in the printing machine, an RFID tag or only the antenna is put onto the substrate, overprinted with multiple inks and checked inline.

DE10335230 describes various methods for producing RFID tags, which are also known as smart labels.

A common feature of the aforesaid protective rights publications is that the areas of use proposed are either the printing of labels for sticking on goods or printing on outer packaging for goods, particularly on pharmaceutical packaging. In respect of the use of RFID tags in the printing industry, which is currently experiencing a high level of recognition, the opinion is that identifying individual products, for example newspapers, is not appropriate, merely for reasons of cost. The IFRA Special Report 04/2006 (published by Ifra, Washingtonplatz 1, 64287 Darmstadt, Germany) entitled “Einsatz von Radio Frequency Identification in der Zeitungsproduktion” [Use of radio frequency identification in newspaper production] even rejects the use of RFID tags for fitting on the dispatched packages from a newspaper print shop as infeasible. Promise is seen only in its use for workflows which relate to stock receipt and warehousing.

Individual identification of printed products, that is to say of main products and/or subproducts, from conventional high-capacity printing during the print further processing takes the known solutions with mechanical systems to high-maintenance and error-prone systems. In the case of known optical systems, the individual identification of printed products by means of image recognition results in extremely complex systems whose complexity means that they become more error-prone and/or require sophisticated superordinate control systems which are inclined to failure and associated system shutdown.

It is therefore the object of the present invention to provide a method and a system for producing flexible, two-dimensional products, preferably multipart printed products, which avoid the drawbacks described above.

It is also the object of the invention to make extensive use of known high-capacity methods and systems during the print further processing in order to provide new methods and systems for producing flexible, two-dimensional products, preferably multipart printed products, which allow inexpensive printed products to be produced which permit a selectable degree of individual identifiability. This object is intended to be achieved for a wide variety of types of printed products, for example also for extensive assembled and/or stapled printed products with product inserts.

A further object of the present invention is to provide a method and a system which easily and inexpensively allow correct addressing and particularly a correct sequence for the products which are to be addressed and those addressed, and hence allow the subsequent delivery with relatively high efficiency without any increased machine sophistication.

This object is achieved by the features contained in the characterizing part of Claims 1, 16 and 17.

The method according to the invention involves flexible, two-dimensional products, preferably printed products which have preferably been produced using a conventional high-capacity printing method, for example forme-bound using rotary printing, being provided with an identification means in the form of an RFID tag in the high-capacity printing apparatus or between the high-capacity printing apparatus and a first further processing apparatus connected downstream of the printing apparatus. The identification means carries at least one piece of 1-bit information for identifying the products and renders said products identifiable. This individual rendering identifiable will subsequently also be referred to as indification. In contrast, it is also possible for groups of products to be provided with an RFID tag having identical identification information, which will be referred to as omnification within the context of this application. By way of example, omnification is appropriate for a region-specific subproduct.

The method according to the invention is used to produce flexible, two-dimensional products. In line with preferred embodiments, multipart printed products are produced which comprise at least one main product and/or one or more subproducts. In the text which follows, the term subproducts is also intended, unless the description explicitly reveals otherwise, to be understood to mean insert sheets, postcards or advertising product inserts, CDs, etc. At least one of the main products and/or subproducts, insert sheets, postcards, advertising inserts, etc. is provided with an RFID tag which has at least one piece of 1-bit control information and/or at least one piece of product information which directly or indirectly controls at least one work step during the print further processing. In the case of direct control, the information read from the RFID tag triggers a work step on at least one workstation, preferably without involving a superordinate control apparatus. When producing a daily newspaper with a region-specific subproduct R and a region-specific advertising insert W inserted in the subproduct R, the direct control can be used, by way of example, to trigger the insertion operation on a feeder with the advertising insert W using a signal coming from the RFID tags of the subproducts R. For correct insertion, the feeder's controller does not need to be in contact with a superordinate control unit, but rather it suffices if the information read from the RFID tag of the subproducts R to be provided with the insert W is recognized and used as a trigger for the insertion of W. In the case of other region-specific products, the feeder for R remains inactive.

In the case of indirect control, on the other hand, the information read from the RFID tag is forwarded to a superordinate control apparatus, processed and a signal is generated which triggers a work step on at least one workstation.

The at least one work step controlled by the RFID tag preferably comprises one of the following activities: conveying, storing, inserting, gathering, assembling, stapling, paging, folding, placing inserts, sticking in, cutting, addressing or packaging. The work step may also be an inspection step.

In line with the novel method, preferably at least one of the main products and/or subproducts is provided with an RFID tag which cooperates with at least one further RFID tag of at least one further main product and/or subproduct and/or insert. This allows at least one piece of information about the composition of the printed product or of a group of printed products to be read contactlessly during the print further processing. The at least two RFID tags modulate an output signal from a transmission unit jointly, so that at least one joint response signal is generated. This response signal influenced by two RFID tags is also referred to as a composed response signal, also called a combi signal. The response signal is modulated, at least in terms of amplitude and/or frequency, in comparison with the output signal by means of the cooperating RFID tags.

The at least one piece of control information and/or at least one piece of product information stored on the RFID tags is a piece of 1-bit or a piece of multibit information. The information can range from a piece of 1-bit information, which allows the presence of an RF-marked product to be established, through to a piece of kilobit or even megabit information, which allows individual identification of every single printed product through to storage of product-specific supplementary information in the form of text, image and/or sound documents or combinations thereof.

Since reading the RFID tags requires no visual contact, and since the RF techniques used allow reading from several centimetres up to over one metre, the positioning of the tags on the products to be identified does not have narrow limits set for it. Preferably, the tags are arranged in fold regions, for example, so as not to adversely affect the free area available in the layout.

If the at least one RFID tag is fitted to the product identified by it in a defined position, this prescribed position of the RFID tag can be used as a further piece of information about the position and orientation of the product for conveying or for storing.

In preferred embodiments based on the present invention, the at least one RFID tag is a read/writable RFID tag, preferably a passive RFID tag, which comprises an antenna and an IC operatively connected thereto, particularly an IC arranged on a chip. In line with preferred embodiments of the present invention, the at least one RFID tag is created in a printing process directly on the product to be provided with the tag, or a previously created RFID tag is fitted in a separate work step to the product to be provided with the tag.

The 1-bit RFID tags according to the invention are preferably created directly on the product to be provided with the tag and, following creation, have a piece of product and/or control information comprising at least one bit written to them, or are created such that they already comprise the desired 1-bit information.

Multibit RFID tags based on the invention have a piece of product and/or control information comprising at least one bit written to them, preferably after they have been created on the product to be provided with the tag or, in the case of separately created RFID tags, after they have been fitted to the product to be provided with the tag.

In line with a first preferred embodiment of the present invention, the identification means comprises a 1-bit RFID tag which has been put onto the printed product in a printing method and can be read and/or altered during the print further processing contactlessly and without visual contact between the tag and the read/write unit.

In line with a further preferred embodiment of the present invention, the RFID tags are not fitted directly in or to the printed product but rather have a resolvable, temporary direct physical association with the printed product. In this case, the identification means may be formed, by way of example, in a transport unit associated with the printed product for a particular period and a particular section of the transport path, for example a rest on a ladder conveyor or a grab on a grab transporter. In line with further embodiments, the RFID tags may be arranged on apparatus parts of buffer and/or storage lines which are in turn associated with an individual printed product or a group of printed products for a particular period and a particular section in a buffer line or a storage path.

In line with preferred embodiments in which the printed products are directly provided with the RFID tags, the RFID tags are fitted to the printed product directly in the high-capacity printing process, or directly downstream of the printing process on the interface for further processing, at any rate ahead of the first downstream handling station. Preferably, it is at least the main products which are indificated in this manner. In the case of printed products assembled in complex fashion, which, by way of example, comprise a main product and a plurality of first-order subproducts and/or advertising inserts, which themselves in turn contain inserted subproducts (second order), the first-order and/or higher-order subproducts or these alone are preferably also provided with an RFID tag.

The indification can, as indicated in FIG. 3, also be limited to individual products in a product group. In this case, not every single product in a product stream along a conveying line or a storage line is provided with an RFID tag, but rather an indificated product with an RFID tag has one or more associated products not provided with an RFID tag. When product groups are indificated, the product with an RFID tag which is arranged at the front in the direction of conveyance can activate a handling station, controlled by the tag, for all subsequent products until a further product provided with an RFID tag deactivates the handling station again. The product groups in the product stream may be of regular composition or may have different sizes.

For the sake of simplicity, the basic concept and fundamental advantages of the invention will first be explained using the example of main products for a daily newspaper which are provided with a 1-bit RFID tag, however. An RFID tag comprising conductive ink is printed onto each main product in a suitable area, for example using a digital printing unit (e.g. an InkJet printer) in or after the rotary section. The RFID tag is preferably positioned in an inner fold region, so that it is not cut away in the event of any marginal bleed and does not adversely affect the layout. By way of example, the RFID tag comprises a printed conductive coil with a capacitor, which form a resonant circuit. When the RFID tag enters the electromagnetic radio frequency field generated by the read/write unit, said field being in tune with the resonant frequency of the radio frequency tags, the resonant circuit modulates the transmitted power of the system by absorbing energy and can be detected by the transceiver as a result. This effect can be shown in a schematic graph, such as in FIG. 4, in which a signal intensity I is plotted on the y axis against a frequency F on the x axis. When there is no RFID tag in the region of the read/write unit, the output signal shown by curve A is not modulated and the response signal has the essentially unaltered amplitude a_{A}. When there is an RFID tag present, the amplitude of the signal is modified in known fashion—in the present example the signal strength of the response signal is reduced to an intensity of a_{B}. The discrete decrease in the signal strength of the response signal indicates to the system that a product provided with an RFID tag is present. If two products provided with RFID tags are in the reading range, the signal strength of the response signal is attenuated again to a_{C}. If a third product provided with an RFID tag is in the reading range, the signal strength is attenuated to a_{D}. The relative intensity or amplitude differences indicated in FIG. 4 between output or challenge and response signals are influenced by a wide variety of interfering factors in industrial use. Preferably, the system parameters, such as frequency, output power, signal strength, distance from the read/write unit to the RFID tags (detection range), stipulation of a predetermined read position, etc., are therefore chosen such that the amplitudes of the challenge and response signals are separate from one another by an adequate distance Δ, so that the response signal picked up by the read/write unit can fluctuate about an amplitude a in a bandwidth of approximately ±Δ/2, and can nevertheless be correctly detected and explicitly associated.

Known problems from the further processing of printed products can be solved elegantly using systems according to the invention. In clamp-type transporters, as have been known from the applicant for many years in various variant embodiments, for example from EP 330868, EP 557680 and EP 600183, often two identical printed products are transported in one clamp in order to increase capacity. To ensure that each clamp holds precisely two products, the presence of two products in the clamp is detected optically, for example. To simplify the optical detection with sufficient accuracy, the two products are held in the clamp not flush, for example, but rather with a vertical offset relative to one another. If the two products are not arranged in the clamp with the necessary accuracy in the necessary relative position relative to one another during such detection, however, the optical inspection system generates an error message, even though the clamp is correctly filled with two products. In line with the invention, the inspection can now be significantly simplified and the rate of error reduced, since what is detected is no longer the positioning of products relative to one another but rather the actual presence of the products. If there is a desired group of two in the clamp, it supplies the read/write unit with a response signal C (as shown in FIG. 4) having the amplitude a_{C}. The system, that is to say at least the read/write unit, has previously been programmed such that it can associate a response signal C with the presence of two products and detects the relevant clamp as being correctly filled. If there is only a single product in a clamp, a stronger response signal B with amplitude a_{B} is generated, and the loading of the clamp is detected as incorrect in the comparison with the response signal A, which is present as a piece of internal setpoint information. Incorrect loading of a clamp with three products is also detected, since it generates an excessively attenuated response signal D with the amplitude a_{D}. It is possible, in principle, for an empty clamp to be detected from the unaltered output signal A with the highest signal intensity aA, but in practice this requires the system to have a piece of supplementary information, such as the regularly clocked sequence of the conveying means, and hence to know when it needs to associate a signal A with a gap between two properly filled successive clamps and when a clamp is empty.

In a product stream which is transported by means of a clamp-type transporter in the direction of conveyance F, there are recurrently incorrectly loaded clamps in the sequence of clamps loaded correctly with two respective products. When a clamp with a product missing reaches the inspection position, the absence of a product in the clamp is detected and an error message e₁ is generated, which is preferably reported via a signal line to a downstream handling unit or a superordinate control system. When a clamp loaded with a surplus product reaches a fixed read/write unit, the incorrect loading e₃ is detected from the excessively weak response signal D. Even with such extremely simple systems, the response signal generated not only comprises the information regarding whether a clamp is incorrectly loaded, but rather the intensity of the response signal is also used to supply the information about the number of products in the clamp.

In line with advantageous embodiments of the present invention, the usually undesirable superimposition of response signals from RFID tags which are close together is not suppressed or avoided by means of sophisticated singularization methods but rather is consciously brought about in order to generate a compiled multibit response signal, which may comprise a piece of metering information, for example, as described above, through the specific cooperation of two or more 1-bit RFID tags.

It is comprehensible that, in line with the present invention, it is also possible to inspect the filling state of pockets in a pocket-type conveyor or of compartments in an inserting drum.

Since the information from the RFID tags can be read by the read/write unit contactlessly and without visual contact, the read/write units can be fitted with great freedom of choice at a suitable location in the further processing installation, for example along a conveying apparatus. Since no visual contact is required between reader and RFID tags, the tags may be fitted to/on any side of the product, that is to say including inside, and it is nevertheless not necessary to open, separate, release or otherwise handle the products for reading and/or writing, which is a significant advantage over optical inspection methods, as are known from U.S. Pat. No. 5,613,669, for example.

A rule of thumb known to a person skilled in the art is that the range of the RFID tags is directly correlated to the length of the antenna of the transceiver and the length of the antenna of the RFID tag. At least the antenna of the read/write unit can be arranged to the side of the product stream, so that the products are routed past the read/write unit at a distance of a few centimetres, for example. Since the RFID tags are preferably arranged in an upper or lateral marginal region on the side of the products which faces the read/write unit, it is possible for the effective distance for reading between the RFID tag and the antenna of the read/write unit to be reduced to a few centimetres.

A short operating distance of this kind is firstly advantageous because it allows small assemblies, short antenna lengths and weak transmitter powers, and secondly a transmission/reception range of a few centimetres meaning that it is not necessary to singularize the response signals for various product groups, for example for the products in successive transport clamps. The existing distance between the product groups is sufficient to ensure that only one product group is in the transmission/reception range at a time.

Although the present description primarily describes products in clamps, it is clear to a person skilled in the art that the inventive idea can be transferred in full to pocket-type or ladder conveyors.

If only small volumes of data need to be able to read from the RFID tags or written thereto, the present invention allows just the currently known RFID technologies to be used to achieve data transfer rates which allow data interchange at practically any point in the conveying path, even in the case of high-capacity further processing installations with processing capacities of up to 80 000 products per hour. If larger volumes of data need to be transferred, it is recommended that this be done by selecting regions of the conveying path on which the speed of conveyance of the products is slowed down.

Such regions can be found in the further processing of printed products, for example in completion controlled in accordance with the invention, which can advantageously be accomplished with all apparatuses for gathering, assembly and insertion in the broad sense. To produce such printed products using high-capacity methods, gathering, inserting and assembly drums or appropriate lines for gathering, insertion and/or assembly are known from Ferag A G, for example. In this case, gathering involves saddle-shaped supports, and insertion and assembly involve V-shaped compartments, being continuously routed past a plurality of addition stations, and each supply device is usually used to add a further component, for example a further sheet or a further subproduct, to the product produced. Gathering starts with an innermost folded sheet, insertion starts with an outermost, folded sheet or main product, and assembly starts with a first component. A person skilled in the art is aware that gathering, insertion and assembly methods can be combined as appropriate. The known high-capacity devices can currently be used to attain capacities of from 40 000 to over approximately 80 000 products per hour. The conveying path for the printed products between two feeders or other handling stations preferably comprises, in inserting drums from Ferag A G, for example, respective regions without axial feed. In the case of gathering apparatuses, such as the saddle-stitching drums from Ferag A G, as are known from U.S. Pat. No. 5,324,014, for example, the read/write units can preferably be arranged in a saddle-shaped support. During gathering in the narrower sense, it has been found appropriate to put the product identifier in a respective lateral region on the prefold, for example, in which case, as for handling in inserting drums, it is not important whether the tags are put on an inner side or an outer side of the products. For a person skilled in the art, the terms main product and subproduct have a clear meaning in connection with the aforementioned types of assembly, gathering and insertion, and he knows the respective relative position of the products with respect to one another, their orientation in the production process and the chronology of their supply.

In the case of inserting drums and saddle-stitching drums, the read/write units can be fitted behind partitions or beneath saddle-shaped rests or integrated into these, so that they can in turn be positioned in direct proximity to the products and the RFID tags fitted thereon. Since the speed of conveyance of the products is greatly reduced in relation to the installation parts provided with read/write units, particularly in the handling drums, and they are sometimes even at a relative standstill with respect to one another, there is a sufficiently long time window available for also transferring large volumes of data in this case. With handling drums, as are known from Ferag A G from EP 550828, the products to be handled pass through a conveying path along the longitudinal axis of the drums, said conveying path corresponding to an irregular coil, with no kind of axial feed affecting the products in certain radial conveying sections, which means that said products are at a standstill relative to one another for approximately 3 seconds relative to partitions or rests on the drums even at full handling capacity of up to 40 000 products per hour. In line with further advantageous embodiments, the read/write units can also be arranged outside of the drums. In the case of known drums with radial division into 40 pockets, the products are conveyed at approximately 0.5 m/s in the direction of rotation.

It is similarly possible to provide linearly revolving spokes of an apparatus, as are known from EP 0095603, for example, or portions of compartments and pockets of apparatuses, as are known from EP 771754, EP 510525 and EP 346578 for example, with the read/write units.

One significant advantage of the invention is that the individualized assembly can be controlled without direct control instruction from the superordinate control system and only by the information contained in the RFID tag. This not only relieves the load on the superordinate controller to an enormous degree but also makes the method significantly more robust, since the already indificated products can be correctly assembled even if the superordinate controller fails totally. To make the system even more solid, all the information required for generating the RFID tags for an entire edition can be stored in the relevant unit, for example in the digital printer in the rotary section, so that said information is available locally and independently of the superordinate controller. In this way, it is also possible, with little sophistication, to provide subproducts delivered by third-party manufacturers with the relevant information and hence to integrate them completely into the production cycle during the further processing.

In line with the present invention, not only is it possible to check bars of subproducts, for example, as are often delivered by external manufacturers, to determine whether they are correct subproducts, but rather, as shown in FIG. 10, it is also a very simple matter to check each bar to determine whether individual subproducts are arranged in incorrect orientations in the bar.

The option of contactlessly reading covered tags is a quite significant advantage for the final inspection of the finished products and also in dispatch, or preparation for dispatch. If it is necessary to ensure that, on the basis of the lottery act, for example, the lottery tickets stuck inside a newspaper edition actually also comprise the advertised number of winning tickets, then the number and identities of the lottery tickets provided in the finished printed products can be detected and documented immediately prior to baling, for example.

If multibit RFID tags are used at least on the main products of the printed products to be produced, it is possible to attain almost any degree of individualization of the multipart printed products to be produced with very little control sophistication and a very streamlined superordinate control system. By way of example, the degree of individualization of the products to be produced can range from main products in which a region-specific subproduct and/or a region-specific advertising insert are inserted through to a newspaper which is compiled completely on an addressee-specific basis and comprises a main product and subproducts which are selected on the basis of a previously known subscriber profile.

The end products to be produced can be provided with addressee-specific advertising, for example an advertising letter addressed personally or pre-addressed response cards, on the basis of address information stored in the RFID tag. In the area of assembly, this can be done, by way of example, by inserting target-group-specific high-quality conventionally produced advertising inserts, sticking in exactly the same postcards, vouchers or product samples and, in the case of RFID tags with appropriate storage capacity, can extend as far as storage of digital addressee-specific information in the RFID tag which the addressee can read and reproduce in audio or visual form using a suitable reader, preferably using his mobile telephone. The RFID tag can thus be used to transfer a ringtone for a mobile phone from an advertising sponsor to the end customer, for example. A person skilled in the art will see the enormous potential for target-group-oriented advertisement, through to fully individualized advertisement, which the system according to the invention provides particularly also through the integration of forme-bound high-capacity printing processes and non-forme-bound information transmission processes when producing a partially individualized printed product, and is capable of utilizing this potential through need-based customization for the specific individual case without involving any inventive step.

The high-quality RFID tags, which can store text, audio or even picture and video files, comprise a powerful IC and are preferably not printed onto the printed products but rather are produced separately and stuck onto the printed products. This can be done very elegantly using apparatuses as are known from EP1106550, EP1086914 and EP1275607 from Ferag A G and are established on the market extremely successfully under the trademark MEMOSTICK®.

If high-quality and hence expensive RFID tags of this kind are intended to be used exclusively or primarily for controlling work steps during the print further processing, the RFID tags similar to MEMOSTICK® can be removed from the products again, for example including from cards or CDs, prior to baling and reused.

When one RFID tag per bale is left on a product, in accordance with one preferred embodiment, it preferably carries the address and delivery information which can be read and used by the carrier of the bale or the recipient thereof using an appropriate reader.

To implement the invention's systems with the previously described RFID tags, read/write units are preferably used which, as system elements, are generic interfaces which facilitate the integration of workstations or system components from third-party providers.

When the present application refers to an RFID tag, this is not intended to mean that such a tag needs to be printed or produced in another way as a three-dimensional unit. It is entirely possible for portions of the RFID tag, particularly of the antenna, to be arranged on different pages or sheets, even from different printed products, so that the portions can be operatively connected to one another for electrical conduction only after folding, gathering or assembly.

In line with further embodiments of the invention, the antenna of the RFID tags is at least partly formed by staples comprising a suitable material, for example preferably comprising copper or a copper-containing bimetal.

The information stored in multibit RFID tags preferably comes from a superordinate control system and is supplied to at least one read/write station online or using a locally readable storage medium and is preferably buffer-stored in the read/write station.

### BRIEF DESCRIPTION OF THE FIGURES

Figures, which merely show exemplary embodiments, are used to explain the invention below. In the figures:

FIG. 1 shows method steps for putting RFID tags onto printed products and for writing to the RFID tags;

FIG. 2 shows method steps for putting RFID tags onto printed products and for writing to the RFID tags in accordance with a further embodiment of the invention;

FIG. 3a shows an individual product provided with an RFID tag;

FIG. 3b shows a product group comprising two successive products, wherein a first product is provided with an RFID tag;

FIG. 3c shows a product group comprising three successive products, wherein a first product is provided with an RFID tag;

FIG. 3d shows a product group having ten successive products, wherein a first product is provided with an RFID tag;

FIG. 4 shows a graph of the modulation of the signal strength of an output signal from a read/write unit by one or more 1-bit or multibit RFID tags;

FIG. 5 shows a graph of the frequency modulation of an output signal from a read/write unit by one or more 1-bit or multibit RFID tags;

FIG. 6a shows a transport clamp, correctly filled with two printed products, in the region of a read/write unit, wherein the printed products are held flush in the region of the fold;

FIG. 6b shows a transport clamp, incorrectly filled with only one printed product, in the region of a read/write unit, wherein the printed product is held in the region of the fold;

FIG. 6c shows a transport clamp, incorrectly filled with three printed products, in the region of a read/write unit, wherein the printed products are held flush in the region of the fold;

FIG. 6d shows a transport clamp, correctly filled with two printed products, in the region of a read/write unit, wherein the printed products are held offset in the region of the fold;

FIG. 6e shows a transport clamp, incorrectly filled with three printed products, in the region of a read/write unit, wherein the printed products are held offset in the region of the fold;

FIG. 6f shows a transport clamp, incorrectly filled with only one printed product, in the region of a read/write unit, wherein the printed product is held in the region of the fold;

FIG. 6g shows a transport clamp, incorrectly filled with only one printed product, in the region of a read/write unit, wherein the printed product is held in the region of the open edge;

FIG. 6h shows a transport clamp, correctly filled with two printed products, in the region of a read/write unit, wherein the printed products are held flush in the region of the open edge;

FIG. 6i shows a transport clamp, incorrectly filled with three printed products, in the region of a read/write unit, wherein the printed products are held flush in the region of the open edge;

FIG. 7a shows a clamp-type conveyor with clamps as shown in FIGS. 6a to 6c, wherein the region of the read/write unit contains a transport clamp correctly filled with two printed products;

FIG. 7b shows a clamp-type conveyor as shown in FIG. 7a, wherein the region of the read/write unit contains a transport clamp incorrectly filled only with one printed product;

FIG. 7c shows a clamp-type conveyor as shown in FIG. 7a, wherein the region of the read/write unit contains a transport clamp incorrectly filled with three printed products;

FIG. 8 shows a conveying device based on a further embodiment of the invention, in which clamps containing products are routed past a series of read/write units;

FIG. 9a shows a view of an overlapped stream, formed by a plurality of correctly oriented products, with a pair of read/write units in a view from above;

FIG. 9b shows a view as shown in FIG. 9a, wherein a product in the overlapped stream is incorrectly oriented;

FIG. 10a shows an exploded view of a product stack (bar) with a group comprising three incorrectly oriented products;

FIG. 10b shows a complete bar as shown in FIG. 10a with a small board at the front and back and strapping;

FIG. 10c shows a schematic illustration of the bar shown in FIG. 10b;

FIG. 11 shows a schematic illustration of a system for producing flexible, two-dimensional products based on a first embodiment;

FIG. 12a shows a schematic illustration of a system for producing multipart printed products based on a further embodiment;

FIG. 12b shows a schematic illustration of a further system for producing multipart printed products;

FIG. 13 shows a schematic illustration of a system for producing multipart printed products based on a further embodiment with a diverter for sorting the products; and

FIG. 14 shows a schematic illustration of a system for producing multipart printed products based on a further embodiment with two rotary section outputs.

### DETAILED DESCRIPTION OF PREFERRED EMBODIMENTS

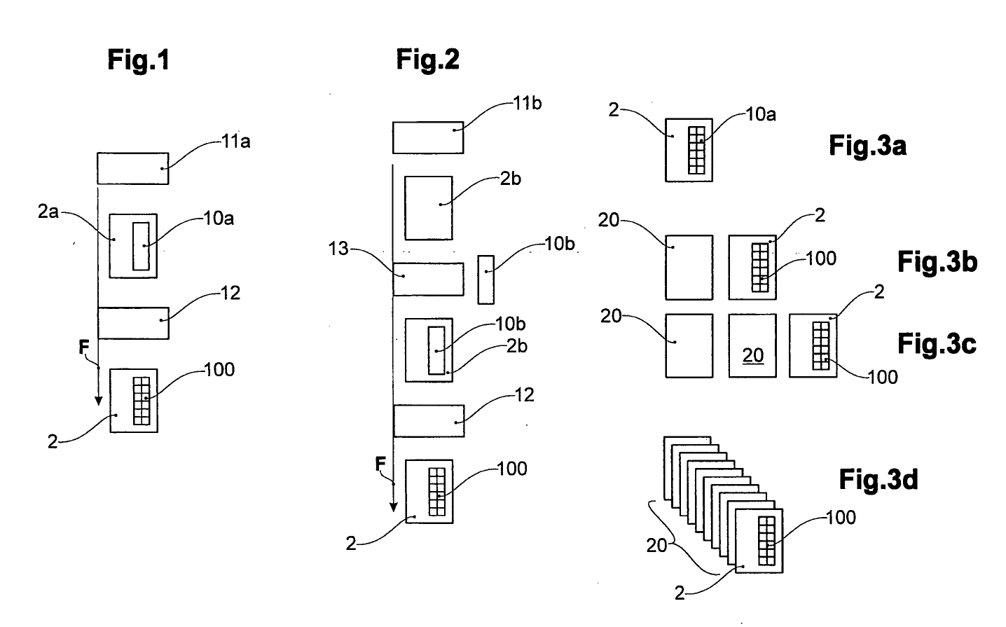

FIGS. 1 and 2 show two different methods for putting RFID tags onto flexible, two-dimensional products 2a, 2b, preferably onto printed products. FIG. 1 shows how, by way of example, a 1-bit or multibit RFID tag 10a according to the invention is created in a high-capacity printing process 11a, or subsequently to such a process, directly on the product 2a to be provided with the tag and is conveyed in a direction of conveyance F. When it has been created, the tag 10a has a piece of product and/or control information comprising at least one bit written to it by means of a write station 12, preferably using a read/write station, so that the RFID tag 100 comprises the desired 1-bit information. This written or information-carrying state of the tag 100 is indicated by the sampling as in FIG. 1.

FIG. 2 schematically shows how an RFID tag 10b created separately after the printing process 11b is put on a product 2b by means of a workstation 13 and then has at least one piece of product and/or control information comprising 1 bit written to it using a write station 12, preferably using a read/write station 12. On the basis of FIG. 2, a person skilled in the art is able to comprehend that the workstation 13 can also be used to put tags which have already been written to or provided with information onto the products 2b.

A common feature of the tags 10a, 10b in FIGS. 1 and 2 is that they can be read and/or altered in the further steps of the print further processing contactlessly and without visual contact between tag and read/write unit.

In line with preferred embodiments, the printed products are provided with 1-bit RFID tags directly in the high-capacity printing process. This means that the handling stations connected directly downstream of the printing process are not absolutely necessary on the interface for further processing, as shown by way of example in FIGS. 1 and 2.

FIG. 3 indicates that, in line with the present invention, it is not absolutely necessary for all the products in a product stream to be provided with RFID tags. FIG. 3a shows an individual product 2 which is provided with an RFID tag 10a which has been written to, as can be produced in method steps as shown in FIG. 1, for example. In FIGS. 3b to 3d, the RFID tags are limited to individual products 2 in a group of products. In this case, not every single product in a product stream along a conveying line or a storage line is provided with an RFID tag, but rather an indificated product 2 with an RFID tag 100 has one or more associated products 20 which are not provided with an RFID tag. When product groups are indificated, the RFID tagged product arranged at the front in the direction of conveyance can activate a handling station, controlled by the tag, for all subsequent products until a further product provided with an RFID tag deactivates the handling station again. The product groups in the product stream may be of regular composition or may have different sizes.

WO 2005/086069A2 respectively describes different apparatus (read/write units) and methods for detecting RFID tags in the communication range of a read/write unit by means of inductive coupling between the field of an antenna on the read/write unit and an antenna on an RFID tag.

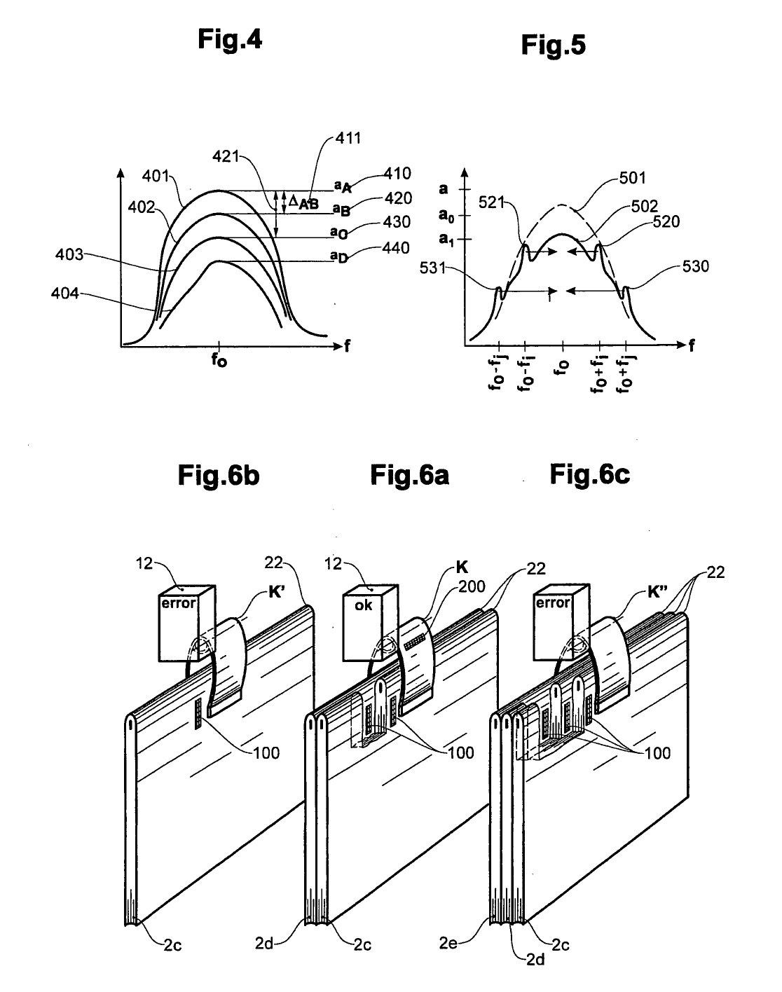

FIG. 4 shows a frequency/amplitude graph with various signals (resonance curves), as applied to a detection antenna on a read/write unit, when the read/write unit (RFID reader of the RFID system) emits a challenge signal of amplitude aₒ at the frequency fₒ, on the basis of whether one or more RFID tags (in the RFID system) corresponding to the challenge signal are in a detection range of the antenna. Corresponding to the challenge signal in this case means that the RFID tag has an antenna or a resonant circuit with a resonant frequency which inductively couples to the frequency fₒ of the challenge signal, so that the detection range contains a response signal (with an amplitude a₁) which differs from the challenge signal (with the amplitude aₒ) by a detectable difference Δ, and/or by a difference Δ which can be evaluated by means of circuitry. The horizontal axis corresponds to the frequency f of the signal, and the vertical axis corresponds to the amplitude a of the signal.

If the detection range does not contain an RFID tag, no inductive coupling takes place between the tag and an RFID reader; the challenge signal is accordingly not influenced and the response signal is not influenced (and corresponds to the challenge signal): resonance curve 401 with amplitude 410. If there is an RFID tag in the detection range, inductive coupling takes place, i.e. the RFID tag influences (attenuates) the challenge signal and accordingly the response signal or the amplitude of the response signal: resonance curve 402 with amplitude 420. In this case, the amplitude of the resonance curve 402 is reduced or attenuated by a difference 411 in comparison with the resonance curve 401.

If there are a plurality of RFID tags in the detection range, the resonance curves for the individual tags overlap and their response signal is reduced to a greater extent in comparison with the reduction for one tag, as indicated by the resonance curve 403 with amplitude 430 and a reduction by a difference 421. This allows the number of RFID tags which are present in the reading range to be detected and checked. By way of example, it is possible to detect and hence count up to 50 tags when they are in the detection range of the RFID reader. This is indicated by means of the resonance curve 404 with amplitude 440.

On the other hand, various tags may be designed such that they influence the challenge signal to different degrees, for example by virtue of the antennas having more or fewer windings, different sizes or geometrical shapes or different thicknesses for the interconnects of the antenna windings. In this way, it is possible to detect or distinguish different RFID tags, particularly different 1-bit RFID tags, for example a first tag with a resonance curve 402 and amplitude 420, a second tag with a resonance curve 403 with amplitude 430 and a third tag with a resonance curve 404 with amplitude 440, in each case in comparison with the challenge signal with the resonance curve 401 and amplitude 410.

The previously described method for measuring or monitoring the amplitude (amplitude monitoring method) can be used to detect both 1-bit RFID tags and multibit RFID tags. In this context, no communication takes place between the RFID reader and the RFID tag in the sense of data being written to or from the RFID reader or the RFID tag (data communication).

The reduction or attenuation by difference Δ (411, 421) of the challenge signal by one or more RFID tags may be between a few one-tenths of a percent and several percent (of the challenge signal), depending on the sensitivity of the detection apparatus (detection circuit). Accordingly, the system sensitivity or system resolution is in the same range, so that an RFID system of this kind can be used to distinguish and detect up to several 100 different states, be they system states in which up to several 100 RFID tags are in the detection range simultaneously or system states in which up to several 100 RFID tags are distinguished. Depending on the system resolution and definition of threshold values, it is also possible to determine the precise number of RFID tags and, by way of example, check that a unit intended for delivery to a particular outlet (kiosk) comprises a defined number of RFID tags or corresponding print products, e.g. precisely 50 newspapers and neither 49 nor 51 newspapers. By way of example, the attenuation is measured by converting the possibly attenuated analogue challenge signal into a digital signal (of the voltage value) in an A/D converter (analogue/digital converter) and comparing it therein with a reference signal which corresponds to the unattenuated challenge signal. In this case, the sensitivity of the detection apparatus, taking account of system noise and environmental influences, is dependent on the resolution or the resolving power of the A/D converter. It is also possible to measure the attenuation by comparing the possibly attenuated analogue challenge signal, possibly after attenuation or division, as an analogue voltage value of a few volts, directly with the reference signal in a comparator. Generally, it is true that the ratios correspond to the change (reduction, attenuation) in the challenge signal in or on the detection antenna and the relevant digital signal (for the voltage value) or the analogue voltage value.

A prerequisite for the number of RFID tags to be able to be detected or RFID tags with different resonant frequencies to be able to be distinguished in such an RFID system, as for the great system sensitivity of between a few tenths of a percent and a few percent, is the almost constant geometric circumstances, particularly the distances between the RFID tags and the RFID reader.

Typical frequency ranges for RFID systems (read/write units with associated RFID tags) or for the frequency fₒ of the challenge signal from the read/write unit are the ISM frequency bands or ISM frequency ranges (Industrial Scientific Medical) of 100-135 kHz, around 6.78 MHz, around 13.56 MHz, around 27.125 MHz, around 40.68 MHz, around 433.92 MHz, around 869 MHz, around 915 MHz, around 950 MHz, around 2.45 GHz and around 5.8 GHz. In general, it is true for passive RFID tags, which do not have their own power supply, for example are supplied with power and operated by means of a battery, and by means of inductive coupling for the field of the challenge signal from the read/write unit, that the desired detection range is determined by the signal strength (output power) of the challenge signal, depending on the size of the antenna or the resonant circuit of the RFID tag. In this case, for the same signal strength and antenna size of the RFID tag, the detection range is firstly greater the higher the frequency of the challenge signal. Since generally a detection range of below 20 cm, preferably from 1 to 10 cm, is desirable, RFID systems with frequencies up to 50 MHz and with an upper detection range of up to 100 cm are used. A 13.56-MHz RFID system with an output power (for the challenge signal) of 200 mW (approximately 20 dBμA/m @10 m) under a detection antenna with a diameter of approximately 10 cm has a detection range of 10 cm (according to the rule of thumb that the diameter of the detection antenna corresponds approximately to the detection range). In this case, the amplitude monitoring method can be used to detect changes in the challenge signal of a few tenths of a dB (0.01 to 0.05 dB), i.e. response signals which differ from the challenge signal by a minimum of 0.2 to 1 mW.

If a single RFID tag or a plurality of RFID tags which are associated with a single print product need to be detected in the detection range, the detection range needs to be physically small; generally, the detection range needs to correspond to the size (the diameter) of the antenna or of the resonant circuit of the RFID tags, and also two print products need to be at a distance which likewise corresponds to at least the size (the diameter) of the antenna or the resonant circuit of the RFID tags, but preferably they need to be at twice such a distance.

Alternatively, it is possible for a plurality of single RFID tags which are respectively associated with a print product to be detected in the detection range. In this case, the detection range and the size of the detection antenna are a multiple of the size (the diameter) of the antenna or the resonant circuit of a single RFID tag. This allows the statistical evaluation of the RFID tags associated with the print products. By way of example, the response signal is evaluated on a rolling basis by groups of ten print products which are respectively in the detection range. If a first group detects all ten of the RFID tags associated with the print products, this group is deemed to be completely or correctly marked for inspection and control purposes, for example. If a second group detects fewer than ten associated RFID tags, the group is deemed to be incompletely or incorrectly marked and can be eliminated or examined further in a subsequent process or in a subsequent RFID reader in order to find the incorrect RFID tag or the print product with the RFID tag which has not been detected, for example on account of incorrect orientation. In this context, some of the print products or RFID tags in the first group may form some of the print products or RFID tags in the second group (rolling bases).

FIG. 5 shows a frequency/amplitude graph with various signals (resonance curves), as are applied to the detection antenna of an RFID reader when the RFID reader emits a challenge signal at the frequency fₒ, on the basis of whether one or how many RFID tags of a second type which correspond to the challenge signal is/are in the detection range of the RFID reader.

If the detection range does not contain an RFID tag then—as described in FIG. 4—no inductive coupling takes place, as indicated by the resonance curve 501. If an RFID tag of the second type is in the detection range, inductive coupling takes place—as described in FIG. 4: resonance curve 502. However, an RFID tag of the second type modulates an auxiliary carrier (subcarrier) at the frequency fi onto the frequency fₒ of the challenge signal (carrier signal, carrier frequency). If no data communication takes place between the RFID reader and the RFID tag, the auxiliary carrier is not modulated and/or encoded. Nevertheless, the auxiliary carrier influences the response signal: the auxiliary carriers 520, 521 manifest themselves as sidebands at the frequency fₒ+fᵢ and fₒ−fᵢ and are used to decide whether the detection range contains an RFID tag.

If there are a plurality of RFID tags of the second type in the detection range, the resonance curves and the auxiliary carriers of the individual tags overlap. A response signal is obtained with two auxiliary carriers (520, 521, 530, 531) with sidebands at the frequency fₒ+fᵢ, fₒ−fᵢ, fₒ+fⱼ and fₒ−fⱼ. In this way, it is possible to detect different RFID tags. The number of tags which can be detected simultaneously in this way is defined, in principle, by the minimum frequency difference between the auxiliary carrier frequencies fᵢ and fⱼ which can still be distinguished in an appropriate detection circuit associated with the prior art (having appropriate bandpass filters for evaluating or detecting the analogue or digitized auxiliary carriers which may be present). For a 13.56-MHz RFID system, the frequency difference between the auxiliary carrier frequencies, and accordingly the auxiliary carrier frequency, is a multiple of approximately 13 kHz, approximately 26 kHz, approximately 53 kHz, approximately 106 kHz or approximately 212 kHz, for example, which are in a range from 9 to 18 MHz, i.e. in a range of ±4.5 MHz, preferably in a range of ±1.5 MHz, around the carrier frequency. An auxiliary carrier frequency of 106 kHz can be used to distinguish and possibly simultaneously detect up to 15 RFID tags in the preferred range of ±1.5 MHz.

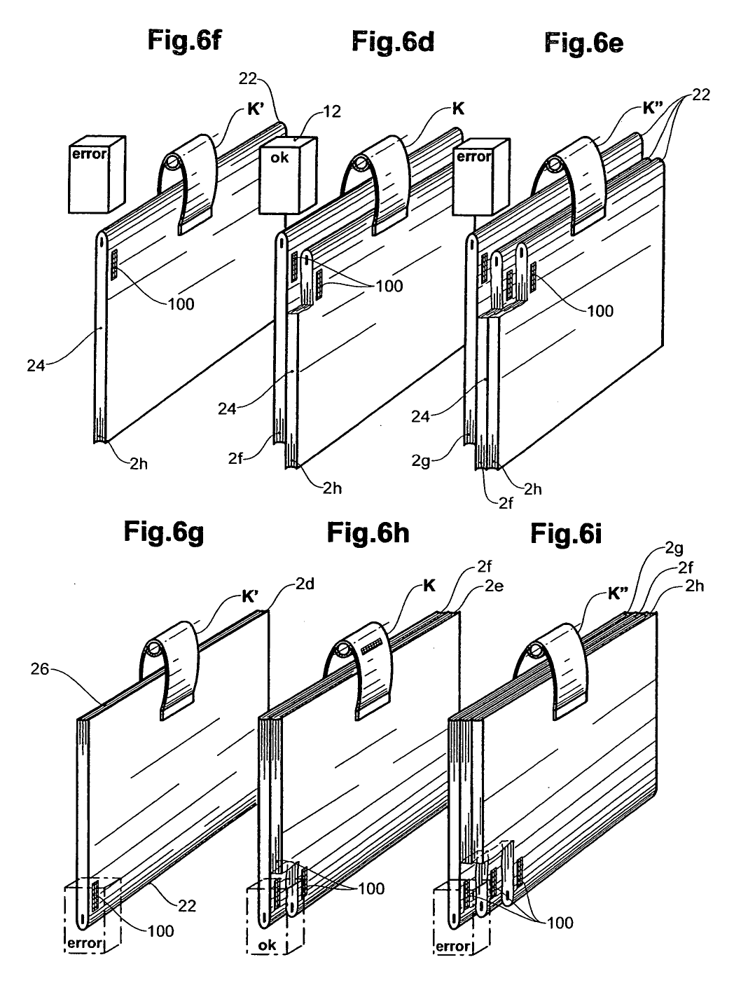

FIGS. 6a to 6i will subsequently be used to show possible applications based on the invention in which it is possible to contactlessly establish what content or what products are being transported by each clamp and possible interaction between the RFID tags on the products held in a clamp and the clamp associated with said products.

FIGS. 6a to 6i respectively show a clamp K, K′, K″ on a conveying means, in this case a clamp-type transporter in accordance with EP 330868, for example, wherein the conveying means itself is hidden to simplify illustration. To provide a better understanding of the engineering and the application possibilities thereof, reference is made by way of example to a case in which a group of two printed products should have been transferred to each clamp K, K′, K″ from an upstream handling means—not designated in more detail.

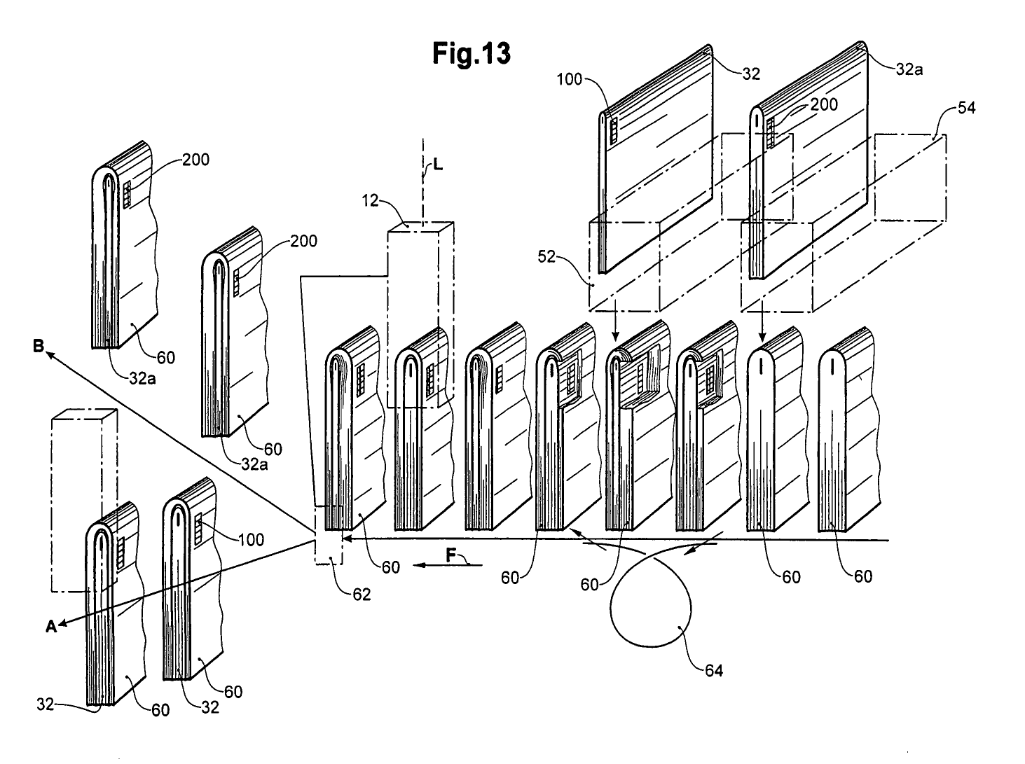

FIG. 6a shows a clamp K on a conveying means in the form of a clamp-type conveyor, in which the product transfer operated as intended and which has received two products 2c and 2d and is now holding them approximately centrally at the fold. The products 2c and 2d may be products in line with the product 2. Both products 2c and 2d are folded products and therefore each have a fold 22 and are both respectively provided with an RFID tag 100 on an outer side of the product 2c, 2d close to the gripping region of the clamp K in proximity to the fold. The product 2c is shown in partial section in the region of its RFID tag 100 so that the RFID tag 100 of the second product 2d is visible. The RFID tag may be an actively or passively responding RFID tag, this having at least one antenna in the case of the latter. To ensure that each clamp is holding precisely two products 2c, 2d, the presence of two products in the clamp is subjected to a detection operation. To this end, the clamp K with the product arrangement shown in FIG. 6 has been drawn along past a write station or read/write station 12, which is essentially stationary relative to the clamp K and which has subsequently produced a response signal C (shown in FIG. 4a) with the amplitude ac. The system, or at least the read/write station, has been programmed beforehand such that a response signal C for the presence of two products is produced and therefore identifies this clamp K as being correctly filled. The response signal can then be read from the RFID tag or the RFID tags by means of a read station or read/write station of appropriate design and transferred both to a superordinate control system and/or to a conveying means, in the present case to the clamp K which has just been checked (as shown in FIG. 6a), by virtue of a further write station or the same station, in the form of a read/write station, converting this response signal C into a piece of 1-bit information, for example, and transferring or communicating it to a further RFID tag 200 which is associated with each clamp K. In the present case, the clamp K is therefore informed that it is gripping a group of two products 2c, 2d and can later forward or use this information, for example for later use, as will be described in relation to FIG. 13. Once the information from the response signal has been transferred to the further RFID tag 200, preferably in the form of an erasable and rewritable RFID tag, in the clamp K, it can conveniently be read again on a further read or read/write station, regardless of the position in space in which the products are situated, whether they are in an overlapped stream or any other formation, or whether the products are still moving, flapping, bulging out or the like, for example after further handling. This also makes the reading operation for the information from the further RFID tag 200 in the clamp K, K′, K″ less dependent on the speed of conveyance of the conveying means, which means that information in buffer lines at lower conveying speeds can be read just as well as information in regular conveying lines at relatively high conveying speed.

It is clear to a person skilled in the art that the RFID tags associated with the products 2c, 2d contain further information about specific properties of the products 2c, 2d, for example when a region-specific subproduct, also referred to as regional portions, is involved. Although the main application of a clamp K, K′, K″ will probably involve only two identical products 2c, 2d being held, it is entirely possible for the products 2c and 2d to be non-identical, region-specific subproducts and for this information also to be stored in different information on the respective RFID tag 100. If such information is intended to be conveyed to the respective clamp, in this case the clamp K, this would also be possible in the form of a piece of multibit information, for example.

FIG. 6b shows a clamp K′ in which the product transfer did not operate as intended and which has therefore received only one of the two products 2c, 2d. Since only a single product is in a clamp K′, a stronger response signal B with amplitude a_{B} has been generated on the read/write station 12, and the loading of the clamp K′ is detected as incorrect, as indicated in FIG. 6b, when compared with the response signal A which is present as a piece of internal setpoint information. The response signal can now be transferred to a superordinate control system and/or to the clamp K which has just been checked (as shown in FIG. 6b) again by virtue of the further write station converting this response signal B into a piece of 1-bit information, for example, and transferring it to an RFID tag 200 associated with the clamp K′.

FIG. 6c shows a clamp K″ in which the product transfer did not operate as intended and which has therefore received three products 2c, 2d, 2e. The incorrect loading of the clamp K″ with three products 2c, 2d, 2e is detected by the read/write station 12, since it generates an excessively attenuated response signal D with the amplitude a_{D}. The response signal of this kind can continue to be used as described above.

In contrast to the products 2c, 2d, 2e shown in FIGS. 6a to 6c, the products 2f, 2g, 2h shown in FIGS. 6d to 6f are each provided with a respective RFID tag 100 on an outer side of the product 2f, 2g, 2h in the region of a free lateral edge 24 in proximity to the fold. For the sake of clarity, the products are shown in partial section. To ensure that each clamp is holding precisely two products 2g, 2f, the presence of two products in each clamp is again subjected to a detection operation. In this case, the sequence for the state shown in FIG. 6d corresponds to that for the state already described with reference to FIG. 6a. The further difference that the two products 2g, 2f have different relative positions (positions of the fold 22) is of no significance for the reading, since the read signal is essentially unaffected thereby. In comparison with conventional optical reading systems, this is a further advantage, since the demands on the orientation of the products in the case of RFID systems are much lower than those in the case of conventional systems. The inspection according to the invention therefore allows the error rate to be significantly reduced, since it is no longer the positioning of products relative to one another that is detected but rather the actual presence of the products.

The sequence in the case of the state shown in FIG. 6f corresponds to that for the state already described with reference to FIG. 6b. This also applies to FIG. 6e, whose state corresponds to the state described in FIG. 6c.

If the products 2f, 2g, 2h are different products, it is technically feasible for the read/write station 12 to read a superimposed signal from the individual RFID tags 100 on the respective products 2f, 2g, 2h, to assess it and to supply this information as a piece of 1-bit information to the further RFID tag 200 in the respective clamp K, K′, K″ and/or to a superordinate system.

In a further embodiment of the invention, which is not shown in more detail, a piece of product and/or control information from a product is not communicated to that element of a facility or conveying means which is associated with the product with the information which has just been read, but rather to an element of this conveying means which precedes this element—as seen in the direction of conveyance F. The term facility is subsequently used as an umbrella term for an apparatus, such as a conveying means, and the term conveying means is in turn used as an umbrella term, for example for a clamp-type conveyor. If the conveying capacity of the conveying means is high, the period in which a product is close to a stationary object is very short. The relative offset between the product and the RFID tag allows more time to be obtained to react to the product in question. As an example of a specific application, a piece of control information from a product which is held in the clamp K is read on a read station 12 and is entered by means of a write station 12a situated downstream into the memory of an RFID tag in a clamp Kₓ which is arranged five clamps downstream of the clamp K in the direction of conveyance F on the same conveying means. This allows a diverter 62, for example, to be notified five clamp intervals ahead of time that it needs to change its tongue to another position when the clamp K arrives at it. The advance information allows, by way of example, time-consuming switching operations to be initiated in good time before the relevant product arrives at this diverter 62.

In a further embodiment, the signal which has been read is supplied to an RFID tag on a product again as information via a write station.

In contrast to those in FIGS. 6f to 6e, the products 2f, 2g, 2h shown in FIGS. 6g to 6i are now not gripped at the fold 22 but rather at the open edge 26 by the clamps K, K′, K″ associated with them. The sequence of the states shown in FIG. 6g to FIG. 6i otherwise corresponds to that in FIG. 6f to FIG. 6e.

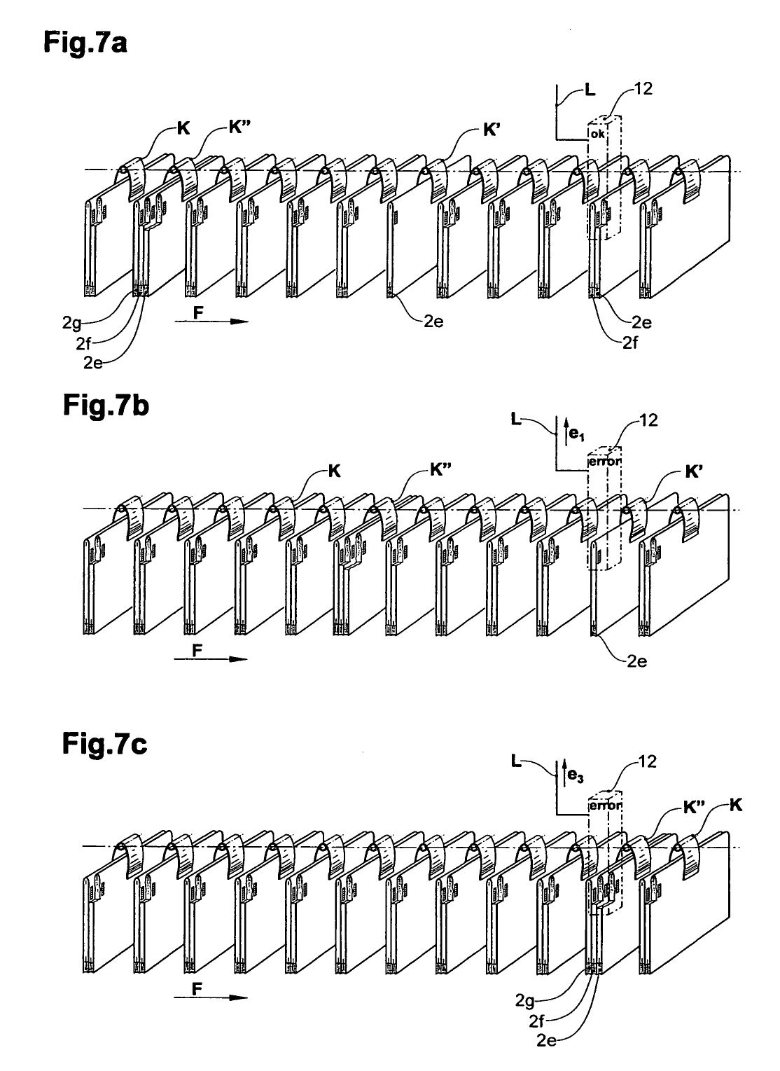

FIG. 7a shows a product stream which is transported in the direction of conveyance F by means of a facility in the form of a clamp-type transporter. For the arrangement of the products in the clamps, of the clamps K, K′, K″ themselves and of the fundamental information read-in and read-out operation, and in respect of the opportunity for product information to be transferred to the respective clamps as required, reference is made at this juncture to the description relating to FIGS. 6a to 6c, and the same product labels are again used therefor. The sequence of clamps correctly loaded with two products 2c, 2d each contains two incorrectly loaded clamps K′and K″. The clamp K′ is loaded with only one product 2c, whereas the clamp K″ has one product 2e too many. When clamp K′, which is missing a product, reaches an inspection position on the read or read/write station 12, which is essentially stationary relative to the clamps, as shown in FIG. 7b, the absence of a product in clamp K′ is detected and an error message e₁ is generated, which is preferably reported to a downstream handling unit or a superordinate control system via a signal line L. When the clamp K″ loaded with a surplus product reaches the read/write unit 12, as shown in FIG. 7c, the incorrect loading e₃ is detected from the weak response signal D. Just in the case of this extremely simple system, not only does the generated response signal comprise the information regarding whether a clamp is incorrectly loaded, but also the information about the number of products in the clamp is supplied by means of the intensity of the response signal.

It goes without saying that the inventive concept is readily also suitable for inspecting the filling state of pockets in a pocket-type conveyor or of compartments in an inserting drum, which is why these are not discussed specifically.

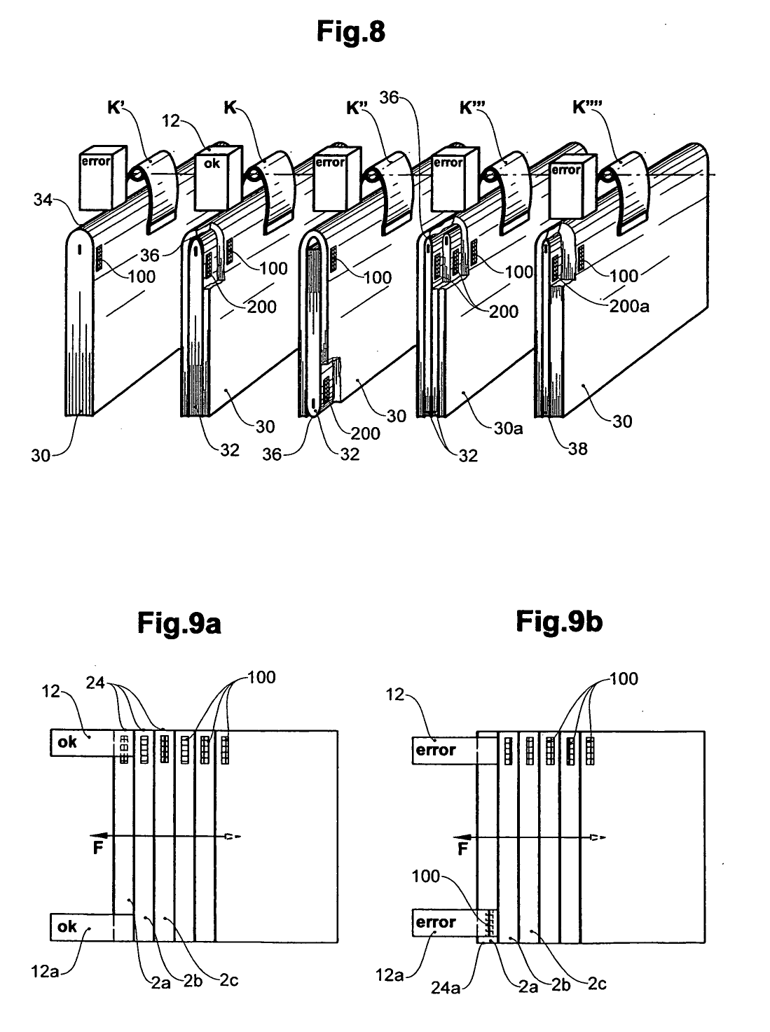

FIG. 8 is intended to illustrate a further, inventive application opportunity for the invention. By way of illustration, it will first of all be explained that a main product 30 with a subproduct 32 in it should have been transferred to the clamps K, K′, K″, K′″, K″″, and the content of clamps K, K′, K″, K′″, K″″ is inspected in order to ensure the transfer. The clamps K, K′, K″, K′″, K″″ grip the main products 30 approximately centrally at the main product fold 34 thereof and clamp the subproduct 32 therein at the same time. The clamp K has received correctly compiled products 30, 32. The read/write unit 12, again connected upstream, has read the information from the products 30, 32 in this clamp K and, in the present case, has transferred the response signal via a write station to the RFID tag (not shown in the figure) in the clamp K. For subsequent handling operations, the clamp K knows that it is filled correctly. A subsequent read/write unit 12 can read this information again.

In contrast to the clamp K, the clamp K′ has received only the main product 30. This information has been detected by the read/write unit 12 and likewise attributed to the clamp K′. The clamp K′ therefore knows that it is not filled correctly, and appropriate measures can be taken in good time in order to prevent such incomplete products from reaching further processing.

Although the clamp K″ has received both the main product 30 and the subproduct 32, these are merely in an undesirable relative position with respect to one another, since the subproduct fold 36 of the subproduct 32 is facing away from the main product fold 34 of the main product 30. Since the clamp K″ conveyed the products 30, 32 past the locally arranged read/write unit, whose antenna was just a few centimetres above the main product fold 34, to the side of the clamp K″, only the response signal from the RFID tag 100 could be read and therefore generated an error signal which, as described above, was transferred to the clamp K″. This shows that the position of an RFID tag can also be used separately as a piece of information.

The clamp K′″ has also not been filled correctly, because it now holds a main product 30 and two subproducts 32, the subproduct fold 36 of which is in the main product fold 34. The read/write unit 12 positioned as just described read the response signal from the RFID tag 100 on the main product 30 and the two RFID tags 200 on the subproduct 32 as a modulated, joint response signal and therefore generated an error signal which was transferred to the relevant clamp K′″ as described above.

The clamp K″″ has likewise not been filled correctly, because it contains an incorrect further subproduct 38, which is admittedly arranged like a correctly oriented subproduct 32 in the main product 30. The read/write unit 12 therefore read the response signal from the RFID tag 100 on the main product 30 and those from the RFID tags 200a on the further subproduct 38 and therefore generated an error signal which was transferred to the relevant clamp K″″ as described above.

Since the information from the RFID tags can be read by the read/write unit contactlessly and without visual contact, the read/write units can be fitted with great freedom of choice at a suitable location in the further processing installation, for example along a conveying apparatus. Since no visual contact is required between reader and RFID tags, the tags may be fitted to/on any side of the product—as in the case shown in FIG. 8—including inside, and it is not necessary to open, separate, release or otherwise handle the products for reading and/or writing, which is a significant advantage over optical inspection methods.

It is clear to a person skilled in the art that, although products are again shown in clamps, the technical teaching can naturally be transferred in full to what are known as pocket-type or ladder conveyors too.

FIGS. 9a and 9b are intended to illustrate a further inventive opportunity for application by inspecting the orientation of the products. FIGS. 9a and 9b each show an overlapped stream of products 2 which are conveyed in a direction of conveyance F. The dashed arrow indicates that it does not matter to the subsequent inspection if the direction of conveyance runs in the opposite direction. Equally, it does not matter whether the RFID tags 100 on the products 2 are exposed or covered by other products. Since the RFID tags 100 are arranged in the region of a free lateral edge 24 of the products 2, the antenna on the read-write unit 12 is also arranged in this region, which normally contains the RFID tags 100. To ensure that no product is incorrectly oriented in the overlapped stream, a further free lateral edge 24a of the products, which is normally opposite the free lateral edge 24, involves the arrangement of an antenna on a further read/write unit 12a.

In FIG. 9a, all the products are oriented as desired in the overlapped stream, which is why the read/write unit 12 can read the signal from every RFID tag 100, while the read/write unit 12a does not receive any kind of signal, since there is no RFID tag in its reading range. Depending on how the conveying speed and/or the settings of the read/write unit 12 are set, the read/write unit 12 can also detect when, although a product is correctly oriented in the direction of conveyance F, it would be oriented the wrong way round in comparison with the intended transverse orientation because, by way of example, its open edge 26 instead of its fold 22 is in front or behind in the direction of conveyance F. This would result in the read/write unit 12 possibly reading a superimposed signal from two or more RFID tags 100 and an error message possibly being generated.

In FIG. 9b, the leading product 2a is oriented incorrectly in comparison with the other, trailing products 2 and further products. As a result, the further read/write unit 12a receives a response signal and produces an error message. In a further embodiment of the invention, the two read/write units 12 and 12a inspect one another. A person skilled in the art will see that the inventive teaching can also be transferred, mutatis mutandis, to the situation in which the read/write unit 12 produces an error message on account of the absence of a response signal from the leading product 2 itself. The error message can subsequently continue to be used as a piece of control information.

Experience has shown that the short distance in the direction of conveyance F from one RFID tag 100 to the next RFID 100 is sufficient to nevertheless be able to read the response signals from said RFID tags explicitly.

In a further embodiment of the invention, possible error messages relating to incorrect product orientation are returned to the respective RFID tags 100 on such incorrectly oriented products 2a by the same read/write unit 12 or a downstream read/write unit in order to influence the further processing of the incorrectly oriented product in question by writing this information to the memory in the relevant RFID tag. In line with further advantageous embodiments, the product information and/or control information and/or further information, such as specific addressee information, is written to the memory or memories in the RFID tag of a specific product or subproduct or of all products or subproducts during the print further processing for example by means of a write or read/write station.

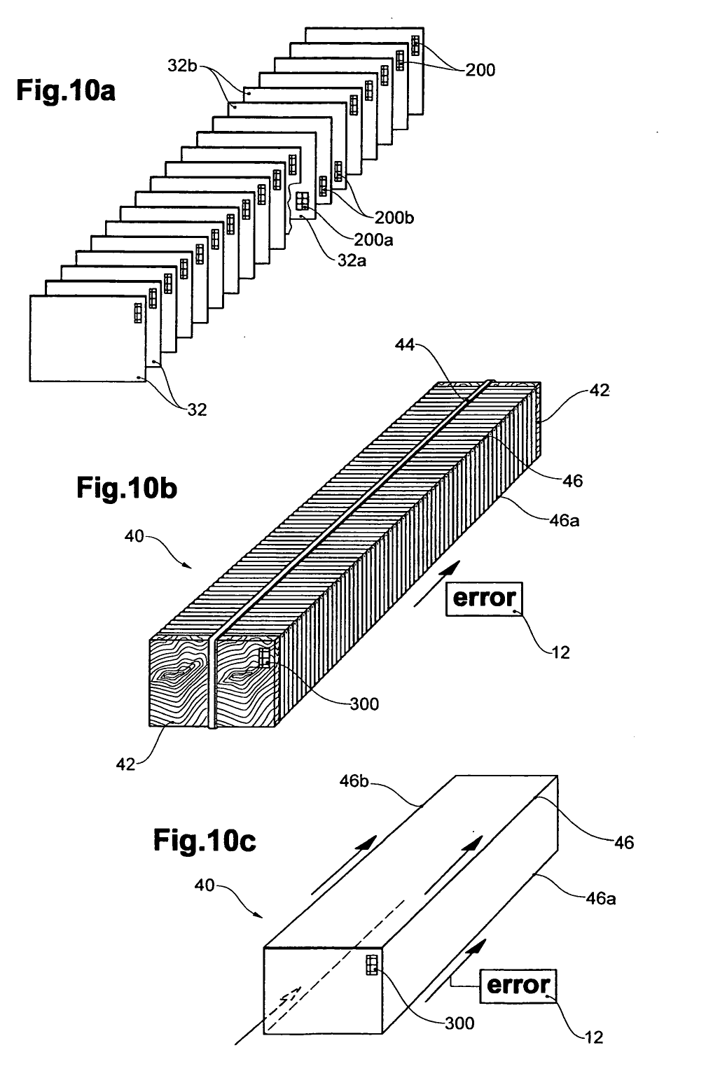

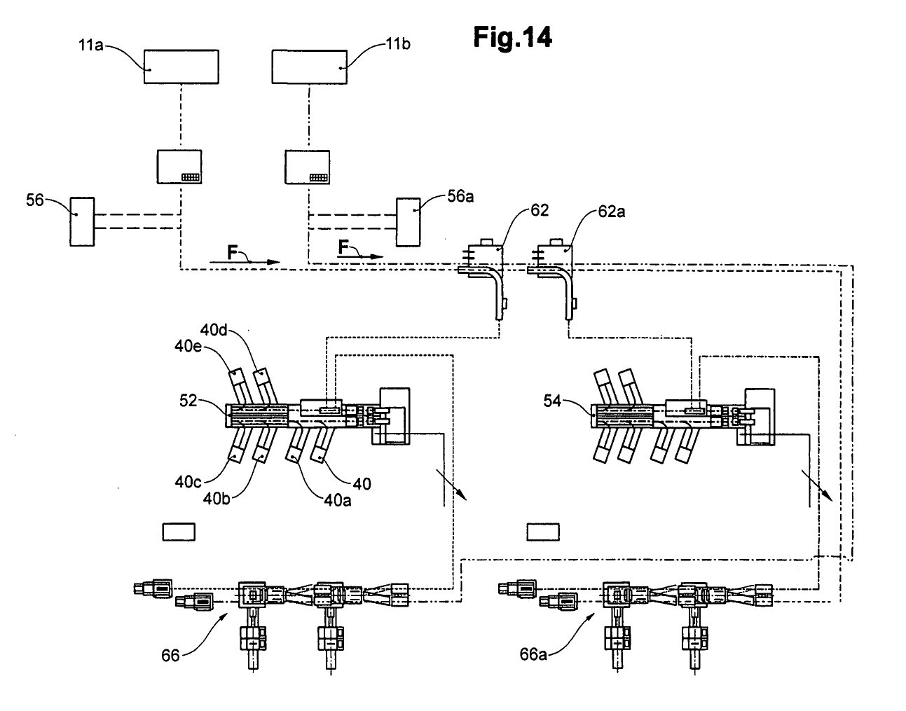

FIGS. 10a to 10c are intended to illustrate a further inventive opportunity for application. In practice, such subproducts for the printing industry are often delivered by external suppliers. In this case, the subproducts 32, 32a, 32b are adjacent to one another, as shown in FIG. 10a, and are held together by means of end pieces 42, subsequently called small boards 42, arranged at the end of such a stack and strapping 44 to form what is known as a bar 40 (see FIG. 10b). When such bars 40 are used, there is the risk in practice that the bar will enter the further processing, for example as shown in FIG. 14, in the wrong orientation, so that its subproducts are twisted to the side or upsidedown in the assembled end product.

If the supplier provides all subproducts 32, 32a, 32b with RFID tags in future, the information contained in these RFID tags can continue to be used for inspection and quality assurance upon entry into the subsequent assembly operation. By way of example, it becomes possible for a read/write unit 12, as already described in detail at other points in this description, to be used to identify incorrect or incorrectly oriented subproducts 200a, 200b during removal from the bar 40 and to separate them in good time, so that no incorrectly compiled end products are produced.

Alternatively, a mobile or fixed read/write unit 12 is moved along the bar edge 46 and/or the bar edges 46a, 46b of the bar 40 in FIG. 10b, which is shown simplified in FIG. 10c, in order to inspect the orientation of the subproducts before the bar 40 actually enters the further processing. When the subproducts are arranged as shown in FIG. 10a, the read/write unit 12 at the bar edge 46b will read incorrect response signals from the incorrect, or incorrectly oriented, subproducts 32a, 32b, and it is possible to take appropriate precautions for the further processing in good time. When the read/write unit 12 moves along the bar edge 46b, no response signal is read in, which is why the incorrect compilation of the subproducts shown in FIG. 10a is not detected.

If there are a wide variety of subproducts in the bar, but their RFID tags are all situated in the region of the bar edge 46, for example, then the read unit or read/write station 12 will nevertheless detect the error.

If the small boards 42 themselves are provided with a single-bit or multibit tag 300 and the subproducts are oriented in a predefined position relative to the small boards, the orientation of the bar 40 can be established upon entry into the further processing operation and, if appropriate, still corrected in good time. The RFID tags 300 may be actively responding RFID tags 300 which respectively comprise an antenna and a chip operatively connected thereto.

A person skilled in the art will also transfer the inventive teaching, mutatis mutandis, to the case in which only the small boards 42 on a bar 40 are provided with an RFID tag 300, but not the subproducts themselves. Thus, at least the correct orientation of the subproducts can be assured when they are supplied to the further processing operation, provided that the subproducts in the bar have been oriented correctly relative to the small boards. In a further embodiment, the strapping 44 itself is provided with an RFID tag.

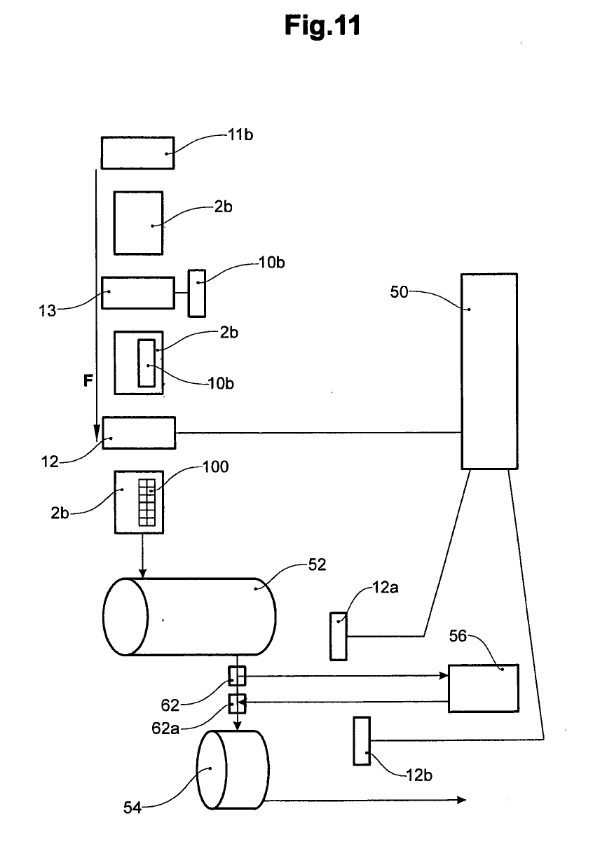

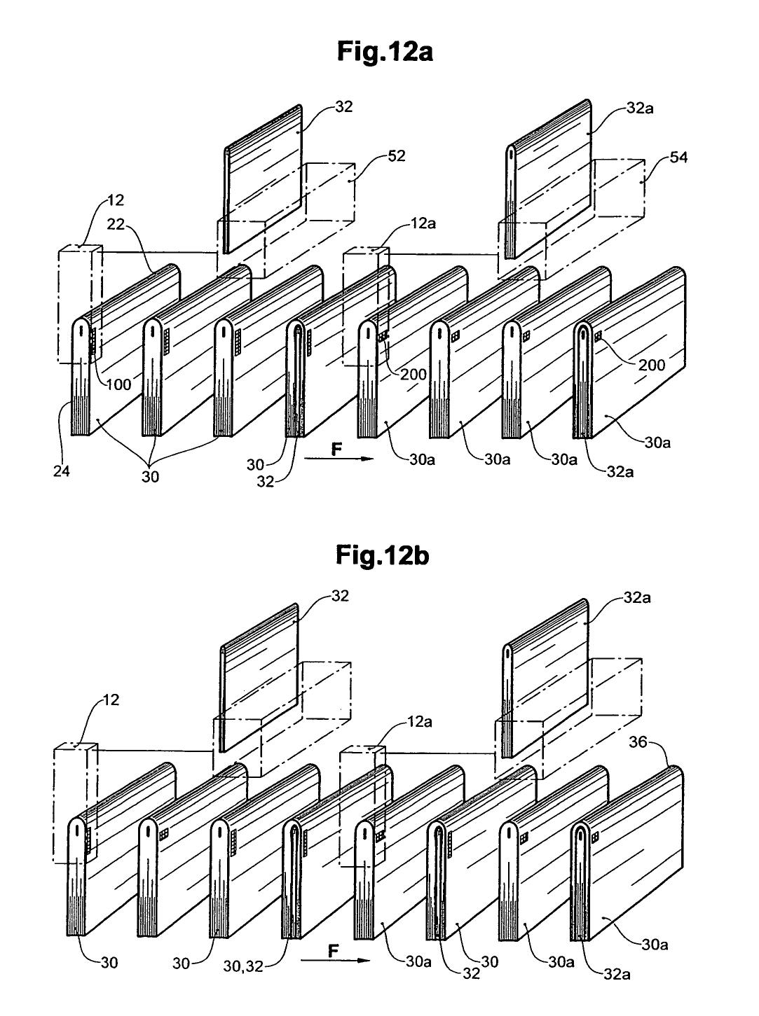

FIG. 11 is intended to use an example to provide a purely schematic illustration of a further inventive opportunity for application. For the manufacture of the product 2b, reference is made at this juncture to the description relating to FIG. 2. In contrast to FIG. 2, the read/write station 12 in this case is provided with the information to be written to the memory of the single-bit or multibit RFID tag 10b on the semi-finished product 2b from a superordinate control system 50. Since the subsequent further handling steps are not significant to understanding this opportunity for application, they are merely referred to as further-handling apparatus 52, 54. In this case, the further-handling apparatus 52 may be a gathering drum from the applicant, for example, which can be used to attain a processing rate of 40 000 to over approximately 80 000 products per hour, while the further-handling apparatus 54 is formed by a cutting drum from the applicant, for example. The material flow of the products is merely shown in stylized form by means of arrows for the sake of simplicity.

When the products 2 are channelled out after the further-handling apparatus 52, they are conveyed along a further read/write station 12a and temporarily stored on what is known as a roller 56, for example, until further use or are subjected to intermediate processing in an apparatus—not described in more detail. The read/write station 12a forwards the information about the response signal from every product provided with an RFID tag whose RFID tag is situated in the range of its antenna to the superordinate control system 50, so that said control system always knows what product—or subproduct—has been branched off from or channelled out of the supply line to the further-handling apparatus 54. From the flow diagram shown in FIG. 11, it is also possible to see that when the products previously channelled out are returned or channelled in they are routed along a further read/write station 12b and the individual product information items from the RFID tags are accordingly forwarded online to the superordinate control system 50 so that the product flow is always essentially fully monitored.

It goes without saying that such outward transfer is, by way of example, particularly suitable for the temporary storage of subproducts such as sheaves of a newspaper which are not required again until the newspaper is compiled. In this case, the RFID tags on the products can control facilities such as diverters 62, 62a themselves, or these are likewise controlled by the superordinate control system 50.

From this embodiment of the invention, a person skilled in the art will see that the inward and outward transfer can be performed in what is known as real-time mode and that it does not matter whether the RFID tags carry what is known as single-bit or multibit information. It is thus possible, by way of example, for the products also to be channelled in and out repeatedly before they are processed from an end product.

FIGS. 12a and 12b are used to describe a further inventive opportunity for application. Two different main products 30, 30a have been marked beforehand with appropriate different RFID tags 100 and 200 in the region of the fold 22 and the free lateral edge 24 and are now transported along further handling stations 52, 54 in the direction of conveyance F. In this case, these further handling stations 52, 54 are formed by feeders 52, 54 which insert different subproducts 32, 32a, for example region-specific subproducts 32, 32a, insert sheets, postcards and/or advertising samples or the like, into the relevant main products 30, 32 according to the read signal therefrom. The RFID tags 200 on the leading products 30a do not trigger a signal when transported along the read/write station 12 which is associated with the feeder 52, which is why they are not loaded with a subproduct 32. By contrast, the further read/write station 12a detects the leading products 30a as such and accordingly prompts the insertion of a subproduct 32a on a further feeder 52 associated with it. The same happens in similar fashion with the main products 30. The insertion is shown only symbolically in FIGS. 12a and 12b and therefore takes place from the bottom in the arrangement shown. While FIG. 12a shows a series of leading first products 30a followed by a series of second products 30, the products 30, 30a are mixed arbitrarily in FIG. 12b. The correct detection of the respective read signals on the read/write stations 12, 12a nevertheless leads to the desired result. A significant advantage of the invention is that the individualized assembly of main products and subproducts 30, 30a, 32, 32a can be controlled reliably without any direct control instruction from a superordinate control system, merely on the basis of the information contained in the respective RFID tag.

A person skilled in the art will see that the same opportunity for application can be achieved if the information is on the RFID tags on the clamps instead of on the RFID tags on the products, as has already been described with reference to FIGS. 6a to 6i.

It is a simple matter for a person skilled in the art to comprehend from the figures that the inventive teaching can also be transferred, mutatis mutandis, to the situation in which the subproducts have their fold 36 supported by saddles and further subproducts and/or a main product are put on astride, for example in the case of gathering and, by way of example, a stapling station, an inspection station, a sticking station, a paging station, a cutting station, an addressing station, a baling station or the like.

As a further inventive opportunity for application for controlling a subsequent operation within the context of the opportunity for application described with reference to FIG. 12, the installation shown in FIG. 13 involves the various RFID tags 100 and 200 on the region-specific subproducts 32, 32a controlling the further course thereof by virtue of their being read by the read/write station 12, which accordingly prompts a diverter 62 to route them in a first direction A or in a second direction B. As in FIGS. 12a and 12b, the unfilled and filled main products are conveyed in the direction of conveyance F by means of a conveying means—not described in more detail. The insertion is likewise shown only symbolically in FIG. 13 and, in the arrangement shown, therefore takes place from the bottom. In contrast to FIGS. 12a and 12b, a loop 64 in the conveying path indicates that the main products 60 undergo yet further handling steps, not described in more detail, between the feeder station 54 and the feeder station 52, for example, and/or are buffered and/or channelled in and out again. As in FIGS. 12a and 12b, various subproducts 32, 32a are gathered or inserted into a main product by feeders 52, 54 associated with said subproducts. In contrast to FIGS. 12a and 12b, these are now neutral main products 60 which become an end product only as a result of the subsequent provision of either one or the other subproduct 32 or 32a. By way of example, such an arrangement allows the regionalized subproducts 32, 32a to determine the dispatch apportionment themselves without the need for a superordinate system for this.

From the figures, it is a simple matter for a person skilled in the art to comprehend that the inventive teaching can also be transferred, mutatis mutandis, to the situation in which the main products in FIG. 13 are not neutral products, that is to say main products 60 without RFID tags, but rather main products equipped with RFID tags, but whose information would not be read in this case. Furthermore, it should be noted at this juncture that all products referred to in this description as main products and/or end product may themselves in turn be subproducts of a superordinate printed product. In a further embodiment of the invention, more complex distribution solutions are implemented by means of a plurality of diverters 62 connected in cascaded series. In addition, a person skilled in the art will see that the same opportunity for application can be achieved if the information is on the RFID tags on the clamps instead of on the RFID tags on the products, as has already been described with reference to FIGS. 6a to 6i, or the products are, mutatis mutandis, supported by saddles, for example on a ladder conveyor, and are gathered mutatis mutandis.

FIG. 14 is intended to serve as a highly schematic example of a complex installation for producing complex printed products. In this case, the dash-dotted lines indicate conveying paths in a direction of conveyance F. By way of example, the production processes 11a, 11b may be high-capacity printing machines which put particular RFID tags as required onto the subproducts or main products directly in this case too. The further-handling apparatuses 56, 56a are formed by winding apparatuses, for example. Further downstream, the products are supplied to subsequent further-handling apparatuses, such as feeders 52, 54, which for their part may contain a plurality of subproducts comprising a plurality of bars 40, 40a, 40b, 40c, 40d, 40e, by diverters 62, 62a in accordance with their information stored in the RFID tags. Next, the end products are prepared for dispatch in further-handling apparatuses formed by dispatch apparatuses 66, 66a, for example. The entire product flow can be inspected and/or controlled either by means of the products themselves or by means of a superordinate control unit, not shown.

It is a simple matter for a person skilled in the art to comprehend that the opportunities for application described above can be combined with one another as desired in order to cope with more complex inspection and/or control tasks.

### LIST OF REFERENCE SYMBOLS

Direction of conveyance F

Clamp K, K′, K″, K′″, K″″

Created, empty 1-bit

RFID tag or multibit

RFID tag 10a

Production process 11a, 11b

Product 2, 2a, 2b, 2c, 2d, 2e, 2f, 2g, 2h

Read station, write station, read/write station 12, 12a

Separately created RFID tag 10b

Workstation 13

Fold 22

Free lateral edge of a product 24, 24a

Open edge of a product 26

Main product 30, 30a

Subproduct 32, 32a, 32b

Main product fold 34

Subproduct fold 36

Further subproduct 38

Bar 40, 40a, 40b, 40c, 40d, 40e

Endpiece, small board 42

Strapping 44

Further RFID tag 300

Bar edge 46, 46a, 46b

Superordinate system 50

Further handling apparatus 52, 54

Another further—handling apparatus, roller 56, 56a

Neutral main product, not fitted with RFID tags 60

Diverter 62, 62a

Loop 64

Dispatch apparatus 66, 66a

RFID tag carrying information 100

Further RFID tag carrying information 200, 200a, 200b

Amplitude a, aₒ, a₁, 410, 420, 430, 440

Difference, amplitude difference Δ, 411, 421

Resonance curve 401, 402, 403, 404, 501, 502

Frequency f, fₒ, fᵢ, fⱼ

1. A method for processing flexible, two-dimensional products during print further processing, comprising:
providing at least one of the products (2, 2a, 2b, 2c, 2d, 2e, 2f, 2g, 2h) with an RFID tag (100, 200, 200a, 200b) which includes at least one piece of control information and/or at least one piece of product information which controls at least one work step during the print further processing.

2. The method according to claim 1, wherein the flexible, two-dimensional products (2, 2a, 2b, 2c, 2d, 2e, 2f, 2g, 2h) are printed products, preferably multipart printed products, comprising at least one main product (30, 30a) and one or more subproducts (32, 32a, 32b), and in that at least one of the main products and/or subproducts, particularly insert sheets, postcards and/or advertising samples is provided with an RFID tag (100, 200, 200a, 200b) which has at least one piece of control information and/or at least one piece of product information which controls at least one work step during the print further processing.

3. The method according to claim 1, wherein the at least one work step comprises one of the following activities: conveying, storing, inserting, gathering, assembling, stapling, paging, placing inserts, sticking, cutting, addressing, packaging, or in that the work step is an inspection step.

4. The method according to claim 1, wherein at least one of the main products and/or subproducts (30, 30a) is provided with an RFID tag (100) which cooperates with at least one further RFID tag (200) on at least one further main product and/or subproduct (32, 32a, 32b) and/or insert, permitting at least one piece of information about the composition of the printed product to be read contactlessly during print further processing.

5. The method according to claim 3, wherein the at least two RFID tags (100, 200, 200a, 200b) modulate an output signal from a transmission unit jointly, so that at least one joint response signal is generated.

6. The method according to claim 4, wherein the response signal has at least the amplitude and/or the frequency modulated in comparison with the output signal.

7. The method according to claim 1 wherein the at least one piece of control information and/or at least one piece of product information stored on the RFID tags (100, 200, 200a, 200b) is a piece of 1-bit or a piece of multibit information.

8. The method according to claim 6, wherein the at least one RFID tag (100, 200, 200a, 200b) 30 is fitted to the product (2, 2a, 2b, 2c, 2d, 2e, 2f, 2g, 2h) identified by it in any position.

9. The method according to claim 6, characterized in that the at least one RFID tag (100) is fitted to the product (2) identified by it in a defined position, so that the position of the RFID tag (100) can be used as a further piece of information.

10. The method according to claim 1 wherein the at least one RFID tag (100, 200, 200a, 200b) is a read/writable RFID tag (100, 200, 200a, 200b).

11. The method according to claim 1 wherein the at least one RFID 10 tag (100, 200, 200a, 200b) is a passively responding RFID tag which comprises at least one antenna.

12. The method according to claim 1 wherein the at least one RFID tag (100, 200, 200a, 200b) is an actively responding RFID tag (100, 200, 200a, 200b) which comprises an antenna and a chip operatively connected thereto.

13. The method according to claim 1 wherein the at least one RFID tag (10a) is created in a printing process (11a) directly on the product (2a) to be provided with 25 the RFID tag (10a).

14. The method according to claim 1 wherein the at least one RFID tag (10b) is created previously and is fitted to the product (2b) to be provided with the RFID tag (10b) in a further step.

15. The method according to claim 14, wherein the at least one RFID tag (10b) has a piece 35 of product and/or control information, comprising at least one bit, written to it before being fitted to the product (2b) to be provided with the RFID tag (10b).

16. The method according to claim 13 wherein the at least one RFID 5 tag (10a, 10b) has a piece of product and/or control information, comprising at least one bit, written to it after being fitted to or created on the product (2a, 2b) to be provided with the RFID tag (10a, 10b).

17. The method according to claim 1 wherein the at least one piece of control information and/or at least one piece of product information is read on a read station or read/write station (12, 12a) of appropriate design.

18. The method according to claim 17, wherein the read information is communicated to a superordinate system (50) or to a conveying means associated with the relevant product, this information preferably being communicated to a clamp (K, K′, K”, K′″, K″″) on the conveying means which is directly associated with the relevant product or with the products with the read information.

19. The method according to claim 1 wherein a further piece of information and/or at least one piece of control information and/or at least one piece of product information is written to the memory of an RFID tag (100, 200, 200a, 200b) of a product (2, 2a, 2b, 2c, 2d, 2e, 2f, 2g, 2h) using a write station 35 or read/write station (12, 12a) of appropriate design.

20. A flexible two-dimensional product (2, 2a, 2b, 2c, 2d, 2e, 2f, 2g, 2h), which can be used during the print further processing, wherein the product (2, 2a, 2b, 2c, 2d, 2e, 2f, 2g, 2h) has at least one RFID tag (100, 200, 200a, 200b) which has or have at least one piece of control information and/or at least one piece of product information which is suitable for controlling at least one subsequent work step in the print further processing and/or at least one subsequent inspection step.

21. The product according to claim 20, wherein the at least one piece of control information and/or at least one piece of product information can be transferred to or from a read station or read/write station (12, 12a) of appropriate design.

22. The product according to claim 20 wherein the product (2, 2a, 2b, 2c, 2d, 2e, 2f, 2g, 2h) is a multipart printed product which comprises at least one main product (30, 30a) and at least one subproduct (32, 32a, 32b), wherein the main product (30, 30a) and at least one of the subproducts (32, 32a, 32b) or at least two of the subproducts (32, 32a, 32b) are respectively provided with at least one RFID tag (100, 200, 200a, 200b), and the at least two RFID tags (100, 200, 200a, 200b) generate a joint response signal when the control information and/or the product information contained therein is read.

23. A bar (40) containing a multiplicity of subproducts (32, 32a, 32b), characterized in that the bar has a further RFID tag (300) which contains at least one piece of product and/or position information concerning the orientation of the subproducts (32, 32a, 32b) contained therein.

24. A system for producing a printed product on the basis of a method according to claim 1.
